(19) United States
(12) Patent Application Publication
(10) Pub. No.: US 2012/0224200 A1
(43) Pub. Date: Sep. 6, 2012

(54) ELECTRONIC DEVICE AND POS TERMINAL

(75) Inventor: Kiyotaka Nihashi, Shizuoka (JP)

(73) Assignee: TOSHIBA TEC KABUSHIKI KAISHA, Tokyo (JP)

(21) Appl. No.: 13/406,907

(22) Filed: Feb. 28, 2012

(30) Foreign Application Priority Data
Mar. 2, 2011 (JP) 2011-045506

(51) Int. Cl. G06K 15/16

(52) U.S. Cl. 358/1.12

(57) ABSTRACT

Embodiments described herein relate to an electronic device including a device body, a touch panel type display unit, a printing unit, and a discharge port. The touch panel type display unit is attached to the device body through a support shaft and rotates about the support shaft to change a posture thereof to a first state in which the display unit is laid along an upper surface of the device body or to a second state in which the display unit is standing from the upper surface of the device body. The printing unit is installed within the device body and performs a printing operation on a medium based on a touch manipulation of the touch panel type display unit. The discharge port is provided adjacent to the support shaft in the touch panel type display unit and discharges the medium printed by the printing unit.

### CROSS-REFERENCE TO RELATED APPLICATIONS

This application is based upon and claims the benefit of priority from Japanese Patent Application No. 2011-045506, filed on Mar. 2, 2011, the entire contents of which are incorporated herein by reference.

### FIELD

Embodiments described herein relate generally to an electronic device, e.g., for use in a Point of Sales (POS) terminal.

### BACKGROUND

Usually, an electronic device such as a POS terminal includes a printing unit provided with a print head and a platen within a device body, and a touch panel type display unit for use by a clerk. The electronic device may further include another touch panel type display unit for use by a customer at an upper surface side of the device body.

In the electronic device, a clerk or a customer manipulates the display unit(s) by performing touch operations, such that a medium is printed on by the print head, and the printed medium is discharged from a discharge port as a receipt.

However, conventionally, because a display unit for a clerk and a display unit for a customer are individually provided, a problem exists that the electronic device becomes structurally complicated and the manufacturing thereof requires significant cost.

To resolve the above problem, a single display unit rotatably attached to a device body through a support shaft to rotate about the support shaft has been developed. This display unit is used by both the clerk and the customer by changing a posture thereof to either one of a first state in which the display unit is laid along an upper surface of the device body and a second state in which the display unit is standing from the upper surface of the device body.

However, in the conventional display unit used by both the clerk and the customer, a discharge port of the medium is provided at the opposite side to the support shaft of the display unit, which requires a long gap between a portion for printing the medium and the discharge port. This causes a long blank portion to be formed between printed portions on the medium. Thus, a problem exists that the medium is wasted.

In order to prevent a blank portion from being formed on the medium, a method of rewinding the medium whenever printing is performed, or a method of mounting the printing unit at the display unit side has been considered.

However, in a method of rewinding the medium whenever printing is performed, printing process efficiency is diminished. Also, in a method of mounting the printing unit at the display unit side, a weight balance becomes unstable and thus the display unit may be damaged.

### BRIEF DESCRIPTION OF THE DRAWINGS

FIG. 1 is a perspective view illustrating a POS terminal according to an embodiment of the present disclosure.

FIG. 2 is a side view illustrating the POS terminal.

FIG. 3 is a side view illustrating the internal configuration of the POS terminal.

FIG. 4 is a side view illustrating a standing state of a touch panel type display unit of the POS terminal.

FIG. 5 is a view illustrating a state of the POS terminal seen from a touch panel type display unit side.

FIG. 6 is a perspective view illustrating a state of the POS terminal seen from a rear side of the touch panel type display unit.

### DETAILED DESCRIPTION

According to one embodiment, an electronic device includes a device body, a touch panel type display unit, a printing unit, and a discharge port. The touch panel type display unit is attached to the device body through a support shaft and rotates about the support shaft to change a posture thereof to a first state in which the display unit is laid along an upper surface of the device body or to a second state in which the display unit is standing from the upper surface of the device body. The printing unit is installed within the device body and performs a printing operation on a medium based on a touch manipulation of the touch panel type display unit. The discharge port is provided adjacent to the support shaft in the touch panel type display unit and discharges the medium printed by the printing unit.

Embodiments will now be described in detail with reference to the drawings.

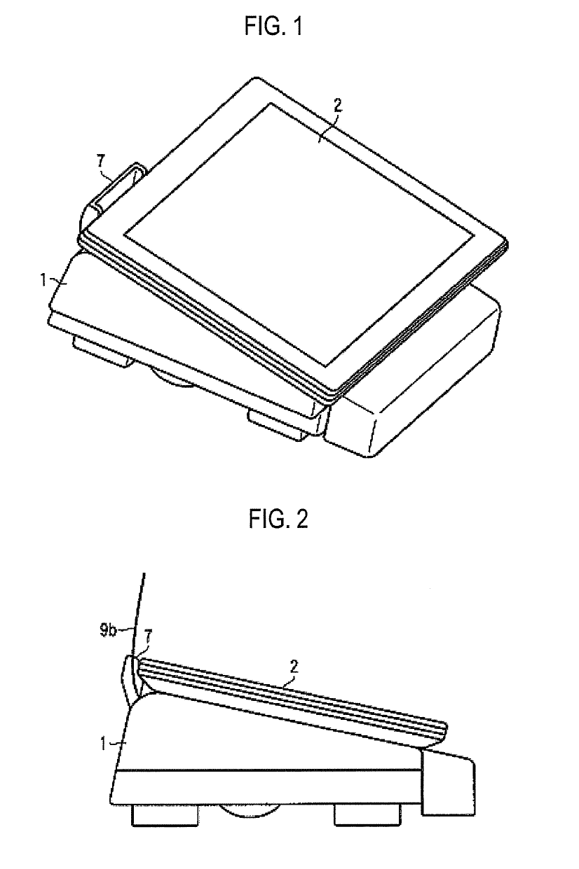

FIG. 1 is a perspective view illustrating a POS terminal as an electronic device, and FIG. 2 is a side view illustrating the POS terminal of FIG. 1.

The POS terminal includes a device body 1, wherein an upper surface of the device body 1 is formed as an inclined surface. Further, a touch panel type display unit 2 is installed at the upper surface of the device body 1. One end portion of the touch panel type display unit 2 is attached to the device body 1 through a support shaft 3 (shown in FIG. 6) so that the touch panel type display unit 2 can rotate about the support shaft 3.

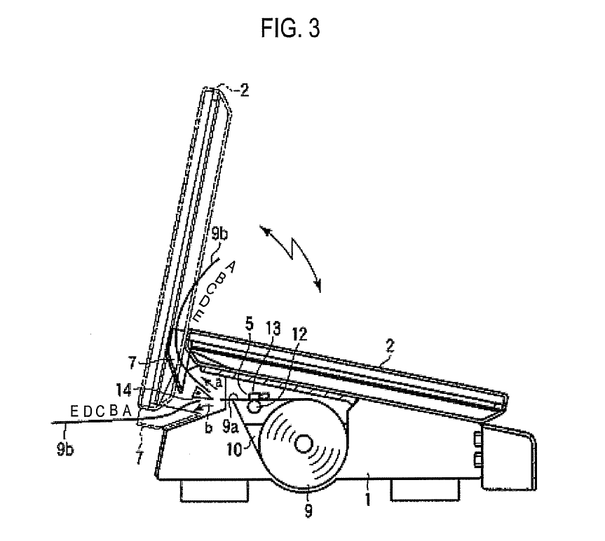

As the touch panel type display unit 2 is configured to rotate about the support shaft 3, the touch panel type display unit 2 may change its posture to either one of a first state in which the display unit is laid along the upper surface of the device body 1 and a second state in which the display unit is approximately vertically standing from the upper surface of the device body 1, as represented by the dotted lines in FIG. 3.

For example, when the touch panel type display unit 2 is used by a clerk, the touch panel type display unit 2 can change its posture to the first state in which the display unit is laid along the upper surface of the device body 1, e.g., such that the clerk can perform touch operations or check product information. On the other hand, when the touch panel type display unit 2 is used by a customer, the touch panel type display unit 2 can change its posture to the second state in which the display unit is approximately vertically standing from the upper surface of the device body 1, e.g., such that the customer can check the product information prior to payment for the product.

In the touch panel type display unit 2, a discharge port 7 for discharging a receipt is provided adjacent to the support shaft 3.

Further, as shown in FIG. 3, at the inside of the device body 1, a paper roll receiving unit 10 for receiving a paper roll 9, which is a printing medium, is installed. The device body 1 further includes a printing unit 5 for performing a printing operation on a sheet 9a withdrawn from the paper roll 9.

As shown in FIG. 6, a cover 17 is installed at the upper surface of the device body 1, and the paper roll 9 is loaded into the paper roll receiving unit 10 by opening the cover 17.

The printing unit 5 is installed adjacent to the discharge port 7 of the touch panel type display unit 2 and includes a platen 12 and a print head 13 disposed opposite to the platen 12. The sheet 9a is interposed between the platen 12 and the print head 13 and is conveyed by a rotation of the platen 12.

Further, at a downstream of the printing unit 5 in a sheet conveyance direction, a cutter (not shown) for cutting the printed sheet into a predetermined size is installed. Also, a guide 14 is provided to be rotatable for guiding the cut sheet (receipt 9b) to the discharge port 7.

When the touch panel type display unit 2 is in the first state in which the display unit is laid along the upper surface of the device body 1, the discharge port 7 is positioned at an upper side facing upward. Further, the guide 14 guides the receipt 9b to the discharge port 7 in a first direction indicated by an arrow a.

On the other hand, when the touch panel type display unit 2 is in the second state in which the display unit is standing from the upper surface of the device body 1, the discharge port 7 is positioned at a lower side facing forward in the sheet conveyance direction. Further, the guide 14 guides the receipt 9b to the discharge port 7 in a second direction indicated by an arrow b.

Additionally, the printing unit 5 is configured to change a printing direction of the printing medium depending on the posture of the touch panel type display unit 2. Specifically, the printing direction in the first state in which the display unit is laid along the upper surface of the device body 1 is reversed in the second state in which the display unit is standing from the upper surface of the device body 1. That is, as shown in FIG. 3, when the display unit 2 is in the first state, information is sequentially printed starting from a front end of the receipt 9b in a discharge direction thereof. For example, if “ABCDE” is to be printed on the receipt 9b, “A,” “B,” “C,” “D,” and “E” are sequentially printed from the front end of the receipt 9b. On the other hand, when the display unit 2 is in the second state, information is printed in a reversed order starting from the front end of the receipt 9b in the discharge direction thereof. For example, if “ABCDE” is to be printed on the receipt 9b, “E,” “D,” “C,” “B,” and “A” are sequentially printed from the front end of the receipt 9b. In this manner, a clerk and a customer can easily read printed contents of the receipt 9b in the first and second states of the touch panel type display unit 2, respectively.

In one embodiment, the touch panel type display unit 2 may change the direction of displaying information depending on the posture of the display unit. Specifically, a screen displayed in the display unit 2 in the first state in which the display unit is laid along the upper surface of the device body 1 may be reversed in the second state in which the display unit is standing from the upper surface of the device body 1. Thus, a clerk and a customer can easily read displayed contents of the screen in the first and second states of the touch panel type display unit 2, respectively.

Although not illustrated in the drawings, in one embodiment, a change of the posture of the touch panel type display unit 2 may be detected using any type of sensor known in the related art. For example, an optical sensor or a gravity sensor may be used to detect the change in the posture of the display unit.

Next, a method of using the POS terminal will be described.

First, when a clerk uses the POS terminal, as shown in FIGS. 1 and 2, the touch panel type display unit 2 is in the first state in which the display unit is laid along the upper surface of the device body 1. In this state, the touch panel type display unit 2 is touch manipulated by the clerk. The platen 12 is driven to rotate based on the touch manipulation and thus the sheet 9a is withdrawn and information is printed on the sheet 9a by the print head 13. The printed sheet 9a is guided to the discharge port 7 in a direction indicated by the arrow a by the guide 14. Further, when a predetermined amount of the sheet 9a is withdrawn, the sheet 9a is cut by the cutter and is discharged from the discharge port 7 as a receipt 9b.

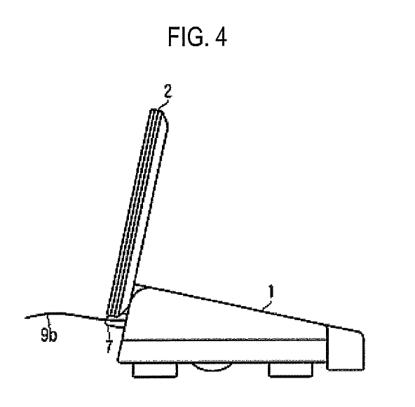

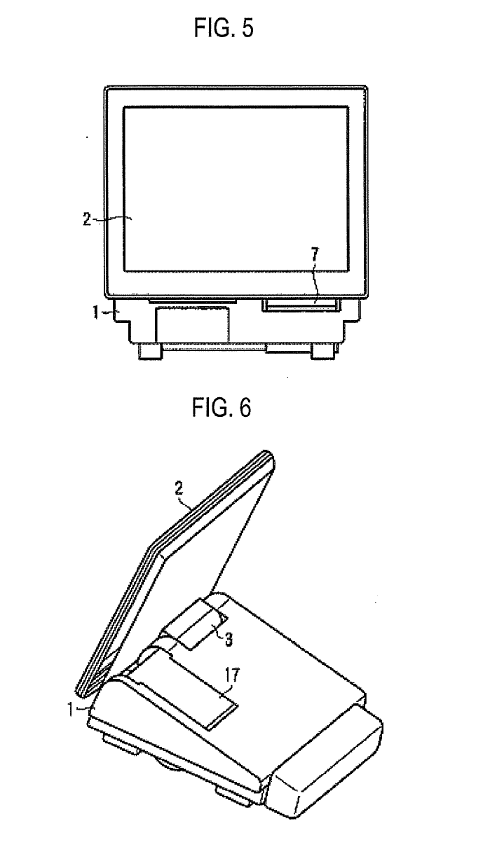

When a customer uses the POS terminal, as shown in FIGS. 4 to 6, the touch panel type display unit 2 is rotated upward, so that the display unit is touch manipulated by the user in the second state in which the display unit is standing from upper surface of the device body 1. As described above, a printing operation is performed by the touch manipulation, and the receipt 9b is discharged downward from the discharge port 7, as indicated by the arrow b.

As described above, according to the present embodiment, in the touch panel type display unit 2, the discharge port 7 is provided adjacent to the support shaft 3 and the printing unit 5 is installed adjacent to the discharge port 7, and thus a distance from the printing unit 5 to the discharge port 7 may be shortened.

Therefore, printing can be performed without rewinding the sheet 9a whenever printing is performed or without mounting the printing unit 5 at the side of the touch panel type display unit 2 to prevent a blank portion from being formed on the sheet 9a. Therefore, printing can be effectively performed without diminution of printing process efficiency or instability of a weight balance of the touch panel type display unit 2.

While certain embodiments have been described, these embodiments have been presented by way of example only, and are not intended to limit the scope of the inventions. Indeed, the novel electronic device described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a device body;
a touch panel type display unit attached to the device body through a support shaft, the touch panel type display unit configured to rotate about the support shaft for changing a posture thereof to a first state in which the touch panel type display unit is laid along an upper surface of the device body or to a second state in which the touch panel type display unit is standing from the upper surface of the device body;
a printing unit installed within the device body, the printing unit configured to perform a printing operation on a medium based on a touch manipulation of the touch panel type display unit; and
a discharge port provided adjacent to the support shaft in the touch panel type display unit, the discharge port configured to discharge the medium printed by the printing unit.

2. The electronic device of claim 1, wherein the printing unit is installed adjacent to the discharge port.

3. The electronic device of claim 1, wherein a printing direction of the medium of the printing unit is changeable according to the posture of the touch panel type display unit.

4. The electronic device of claim 1, wherein a screen displayed in the display unit is changeable according to the posture of the touch panel type display unit.

5. A Point of Sale (POS) device comprising:
a device body;
a touch panel type display unit attached to the device body through a support shaft, the touch panel type display unit configured to rotate about the support shaft for changing a posture thereof to a first state in which the touch panel type display unit is laid along an upper surface of the device body or to a second state in which the touch panel type display unit is standing from the upper surface of the device body;
a printing unit installed within the device body, for the printing unit configured to perform a printing operation on a medium based on a touch manipulation of the touch panel type display unit; and
a discharge port provided adjacent to the support shaft in the touch panel type display unit, for the discharge port configured to discharge the medium printed by the printing unit.

6. The POS device of claim 5, wherein the printing unit is installed adjacent to the discharge port.

7. The POS device of claim 5, wherein a printing direction of the medium of the printing unit is changeable according to the posture of the touch panel type display unit.

8. The POS device of claim 5, wherein a screen displayed in the display unit is changeable according to the posture of the touch panel type display unit.
